(19) United States
(12) Patent Application Publication
(10) Pub. No.: US 2006/0003175 A1
(43) Pub. Date: Jan. 5, 2006

(54) Fluoropolymer molding and laminate thereof

(75) Inventors: Jun Kanega, Kitaibaraki-shi (JP); Takashi Enokida, Kitaibaraki-shi (JP)

Correspondence Address: BUTZEL LONG, 350 SOUTH MAIN STREET, SUITE 300, ANN ARBOR, MI, 48104, US

(73) Assignee: UNIMATEC CO., LTD.

(21) Appl. No.: 11/128,753

(22) Filed: May 13, 2005

(30) Foreign Application Priority Data
May 17, 2004 (JP) 145825/2004

(51) Int. Cl. B32B 27/08

(52) U.S. Cl. 428/474.4; 526/250; 526/247

(57) ABSTRACT

A fluoropolymer molding, which comprises a perfluoropolymer capable of undergoing low-temperature melt molding and having a calorimetric value of crystal fusion of not more than 10 J/g and an MFR (230° C.) of 0.1 to 100 g/min. the molding having a surface modified to have bonds of nitrogen atom origin, where the modification to the surface having bonds of nitrogen atom origin is carried out by electric discharge treatment in an ammonia gas atmosphere. The thus obtained perfluoropolymer molding with a high fluorine content of not less than 72 wt. % can be easily formed into a laminate with other substrates.

### BACKGROUND OF THE INVENTION

1) Field of the Invention

The present invention relates to a fluoropolymer molding and a laminate thereof, and more particularly to a fluoropolymer molding with good surface adhesiveness and surface chemical resistance, and a laminate thereof.

2) Related Art

Fluoropolymers can be produced by copolymerization reaction of fluoromonomers such as vinylidene fluoride, tetrafluoroethylene, hexafluoropropene, chlorotrifluoroethylene, perfluoro(propyl vinyl ether), perfluoro-(ethyl vinyl ether), perfluoro(methyl vinyl ether), etc., and have various characteristics in a wide range of from the elastomeric region to the resinous region, particularly a distinguished heat stability at elevated temperatures and distinguished toughness and flexibility at extremely low temperatures due to the nature of the fluoropolymers, and furthermore much distinguished characteristics such as chemical resistance, chemical stability, non-tackiness, low friction characteristics, electrical characteristics, etc. Thus, the fluoropolymers have been used in various fields such as semiconductors, automobiles, architecture, electric•electronics, food, etc.

Application fields particularly based on the non-tackiness and low friction characteristics of the fluoropolymers are various and numerous, including anticorrosive materials, lining materials, insulating materials, electric wire-insulating materials, etc., but due to the low level of surface free energy, the fluoropolymers have such a problem as difficult bonding to other materials such as thermoplastic or thermosetting resins, metals, glass, etc.

So far, various methods for bonding fluoropolymers to other materials have been proposed, for example, (1) a method for utilizing an anchor effect between a fluoropolymer and a substrate by surface roughening treatment of the substrate by a physical means such as sand blasting, etc., (2) a method for chemically or physico-chemically activating the surface of fluororesin by surface treatment such as sodium etching, plasma treatment, photochemical treatment, etc., and (3) a method using an adhesive (JP-A-3-290442, JP-A-2-23868, JP-A-1-158967, and JP-A-62-81425).

The fluoropolymers are many and various, covering a wide range from those with a lower fluorine content such as poly(vinylidene fluoride), ethylene-tetrafluoroethylene copolymer, vinylidene fluoride-hexafluoropropene-based copolymer, vinylidene fluoride-tetrafluoroethylene-based copolymer to those with a higher fluorine content such as perfluoro-polymers, e.g. poly(tetrafluoroethylene), tetrafluoroethylene-perfluoro(alkyl vinyl ether) copolymer, tetrafluoroethylene-hexafluoropropene copolymer, etc. The higher the fluorine content, i.e., the nearer to perfluoropolymers, the lower the surface free energy level and the more difficult bonding to other materials.

### SUMMARY OF THE INVENTION

An object of the present invention is to provide a fluoropolymer molding with distinguished adhesiveness and chemical resistance, capable of easily forming laminates with other substrates, which comprises a molding of perfluoropolymer with a higher fluorine content.

The object of the present invention can be attained by a fluoropolymer molding, which comprises a molding of perfluoropolymer capable of under-going low-temperature melt molding and having a calorimetric value of crystal fusion of not more than 10 J/g and a melt flow rate (MFR; 230° C.) of 0.1 to 100 g/min., the molding having a surface modified to have bonds of nitrogen atom origin. Modification to the surface having bonds of nitrogen atom origin is carried out by electric discharge treatment in an ammonia gas atmosphere.

The present fluoropolymer molding with a modified surface has distinguished adhesiveness and chemical resistance, and thus can be formed into a laminate with other substrates such as resins, rubbers, metals, glasses, etc. by simple heat fusion bonding.

Reasons why the good adhesiveness can be attained between the perfluoro-polymer molding and the substrate by plasma treatment using an ammonia gas have not been fully clarified, but the surface analysis by X-ray photo-electron spectroscopy (XPS) revealed new bond peaks originating from 1S electrons of N atoms due to the ammonia plasma treatment, which is enough to presume that the ammonia gas was bonded to the molding surface in some forms. Furthermore, it was found that CF₂ bond peak intensity originating from 1S electrons of C atoms was lowered and the C atoms bonded to O atoms of alcohol, ether, carbonyl, carboxyl groups, etc. were newly formed, which is also enough to presume that necessary polar functional groups for a higher bonding strength are formed on the surface of perfluoropolymer molding.

### BRIEF DESCRIPTION OF DRAWING

FIG. 1 shows the standard for evaluation marks of adhesiveness.

### DETAILED DESCRIPTION OF THE INVENTION

Perfluoropolymers for used in the present invention are not limited, so long as they can form moldings, and, for example, TFE-FAVE-based copolymers such as TFE-FEVE copolymer, TFE-FMVE copolymer, TFE-FPVE-FEVE terpolymer, TFE-FPVE-M-VE terpolymer, TFE-FEVE-FMVE terpolymer, etc. can be used preferably, where TFE stands for tetrafluoroethylene, FMVE: perfluoro(methyl vinyl ether), FEVE: perfluoro(ethyl vinyl ether), FPVE: perfluoro(propyl vinyl ether), and FAVE: perfluoro-(alkyl vinyl ether).

In the TFE-FAVE-based copolymers, it is a limit to copolymerize about 40 mol. % of FAVE containing O-atoms that lower the fluorine content, so the maximum fluorine content of perfluoropolymers having a socalled high fluorine content is about 72 wt. % in such a critical copolymeri-zation composition ratio.

The perfluoropolymers for use in the present invention have a calorimetric value of crystal fusion ΔHm of not more than 10 J/g, preferably not more than 5 J/g or undetectable, and an MFR (230° C.) of 0.1 to 100 g/10 min., preferably 1 to 50 g/10 min. By using a perfluoropolymer within the afore-mentioned ranges of the calorimetric value of crystal fusion and the MFR, the melt processing working will be improved in a relatively low temperature range such as about 100° to about 260° C., and particularly in the case of lamination with resin or rubber-based substrate the lamination can be carried out without any thermal decomposition of the substrate. In the case that the perfluoropolymer is a tetrafluoroethylene-perfluoro(alkyl vinyl ether) copolymer, the calorimetric value of crystal fusion ΔHm of the perfluoropolymer can be made not more than 10 J/g by increasing a copolymerization composition ratio of the latter comonomer, perfluoro(alkyl vinyl ether), thereby lowering the crystallinity.

Typical shapes of fluoropolymer molding, which comprises perfluoro-polymer, include a film form, a sheet form, a tube form, a pipe form, a hose form, a block form, a rod form, etc. In the case that the fluoropolymer is laminated as the outermost layer, the film form or the sheet form is preferable.

An inductive coupling-type electrode is suitable for the surface electric discharge treatment, normally plasma treatment, of fluoropolymer moldings. The inductive coupling-type electrode includes, for example, a coil electrode in any coil diameter, whose electrode height is set normally to about 20 to about 200 mm, preferably to about 50 to about 150 mm. An ammonia gas pressure in a vacuum vessel provided with the inductive coupling-type electrode is normally about 0.01 to about 1 Pa, preferably about 0.03 to about 0.20 Pa, and the ammonia gas in introduced into the vacuum vessel is introduced at a gas flow rate of normally about 1 to about 500 sccm, preferably about 2 to about 50 sccm.

A high frequency power source with a frequency of normally a several 100 to a several 10 MHz is used, but from the practical viewpoint it is preferable to use a power source with 13.56 MHz, an industrially allocated frequency. Discharge power in a range of normally about 5 to about 5,000 W, preferably about 10 to about 1,000 W, is used, and the plasma treatment time, though dependent on the discharge power, but in the case that the discharge power is, for example, 300 W, is normally about 1 to about 60 minutes, preferably about 5 to about 30 minutes.

The fluoropolymer moldings with the ammonia plasma-treated surfaces can be bonded to various substrates, e.g. thermoplastic or thermo-setting resins such as polyacrylate-based resin, polyamide-based resin, polyester-based resin, polycarbonate-based resin, polyurethane-based resin, various fluoropolymer-based resins as already mentioned before, heat-resistant polyimide resin, etc., rubbers such as polyurethane rubber, etc., metals, glass, etc. by heat fusion bonding to form laminates.

The surface-treated moldings can be bonded and laminated with substrates, if the moldings are in a film or sheet form, by pressure fusion bonding, using winding rolls heated normally at about 30° to about 300° C., preferably about 50° to about 280° C., under pressure of normally about 0.1 to about 30 MPa, preferably about 0.5 to about 10 MPa. It is also possible to apply an adhesive, etc. to the plasma-treated surfaces of the moldings, followed by pressure bonding. In the case of tube form, pipe form, hose form, rod form, etc., the outer peripheral surface of a substrate having such a form is wrapped with the surface-treated fluoropolymer film heated in advance, followed by pressure bonding to attain lamination. In the case of a laminate whose inner layer is composed of a fluoropolymer molding having such a form, the surface of such a molding is plasma-treated and then wrapped with a substrate film, followed by pressure bonding to attain lamination.

### PREFERRED EMBODIMENTS OF THE INVENTION

The present invention will be described in detail below, referring to Examples.

### Reference Example 1

An SUS316 autoclave having a capacity of 100 L, provided with a stirrer was evacuated, and then 50.0 kg of perfluoro(2-n-butyltetrahydro-furan) was charged thereto. After further evacuation and nitrogen flushing of the autoclave 14.0 kg of tetrafluoroethylene CTFE) and 30.0 kg of perfluoro(ethyl vinyl ether) [FEVE] were charged thereto as initial charges and heated to 30° C., whereby the inner pressure of the autoclave reached 0.75 MPa gage. Then, a solution of isobutyryl peroxide in CF₃CF₂CHCl/CClF₂CF₂CHClF was added thereto as an initiator by a metering pump to initiate polymerization reaction. Polymerization reaction was continued until the inner pressure reached to 0.55 MPa gage.

Then, the autoclave was evacuated with stirring by a vacuum pump through a trap for collecting the solvent and unreacted monomers by cooling, whereby the solvent and unreacted monomers were completely removed from the autoclave. The resulting polymer was then taken out of the autoclave, washed with deionized water, and recovered by a centrifugal filter, followed by vacuum drying, whereby powdery white fluoropolymer was obtained. The resulting fluoropolymer A had a composition ratio by IR of TFE/FEVE=93/7 mol. % (F content: 75 wt. %), a calorimetric value of crystal fusion ΔHm=3 J/g, and an MFR=10 g/10 min.

Determination of a calorimetric value of crystal fusion: according to such a temperature program of heating a sample at a temperature elevation rate of 10° C./minute from 30° C. to 300° C., then cooling down to 30° C. at a temperature lowering rate of 10° C./minute, and then reheating at a temperature elevation rate of 10° C./minute up to 300° C., a calorimetric value absorbed by the endothermic peak as measured by a calorimeter Model DSC220C, made by Seiko Instrument Co., was designated as a calorimetric value of crystal fusion

Determination of MFR (melt flow rate): Melt viscosity of fluoro-polymer was measured by a meltindexer, made by Toyo Seiki Seisakusho Co. At the measurement, the fluoropolymer was placed in a cylinder, 9.5 mm in inner diameter, kept therein at 230° C. for 5 minutes, and then extruded through an orifice, 2.095 mm in inner diameter and 8.00 mm length, under a piston load of 5 kg to determine an extrusion rate at that time

### Reference Example 2

In Reference Example 1, the initial charges were changed to 14.0 kg of tetrafluoroethylene [TFE], 28.0 kg of perfluoro(ethyl vinyl ether) [FEVE], and 28.0 kg of perfluoro(propyl vinyl ether [FPVE] and polymerization reaction was continued until the inside pressure of the autoclave was changed from 0.76 MPa gage to 0.54 MPa gage. The resulting fluoropolymer B had a composition ratio by IR of TFE/FEVE/FPVE=85/8/7 mol. % (F content: 75 wt. %), and an MFR=20 g/10 min., while the calorimetric value of crystal fusion was undetected.

### Reference Example 3

In Reference Example 1, the initial charges were changed to 14.0 kg of tetrafluoroethylene [TFE] and 23.0 kg of perfluoro(methyl vinyl ether) [FMVE], and polymerization reaction was continued until the inside pressure of the autoclave was changed from 0.75 MPa gage to 0.53 MPa gage. The resulting fluoropolymer C had a composition ratio by IR of TFE/F MVE=80/20 mol. % (F content: 74 wt. %) and an MFR=50 g/10 min., while the calorimetric value of crystal fusion was undetected.

### Reference Example 4

In Reference Example 1, the initial charges were changed to 10.0 kg of tetrafluoroethylene [TFE] and 35.0 kg of hexafluoropropene [HFP], and polymerization reaction was continued until the inside pressure of the autoclave was changed from 0.75 MPa gage to 0.55 MPa gage. The resulting fluoropolymer D had a composition ratio by IR of TFE/HFP=93/7 mol. % (F content: 76 wt. %), the calorimetric value of crystal fusion ΔHm=7 J/g, and an MFR=0 g/10 min.

### Examples 1 to 3 and Comparative Example 1

The foregoing fluoropolymer A, B, C or D was molded into a 0.1 mm-thick film under the following extrusion molding conditions, using an extrusion molding machine, Model TP-30, made by thermoplastic Co:

Fluoropolymer

| Set temperature (° C.) | A | B | C | D |
|---|---|---|---|---|
| Molding outlet side | | | | |
| Die | 260 | 230 | 210 | 370 |
| Melting heater inside | | | | |
| Head cylinder | 260 | 230 | 210 | 360 |
| Intermediate cylinder 1 | 240 | 210 | 190 | 340 |
| Intermediate cylinder 2 | 220 | 180 | 160 | 320 |
| Charge resin feed side | | | | |
| Rear cylinder | 200 | 170 | 150 | 300 |

The resulting films were subjected to plasma surface treatment under a high frequency (frequency: 13.56MHz) in an ammonia gas atmosphere under the condition of gas pressure: 0.1 Pa, gas flow rate: 20 sccm and electrode height: 120 mm, using a dry etching apparatus Model RBH-3030, made by ULVAC Co. for a predetermined time as given in the following table, and the adhesiveness and chemical resistance of the resulting surface-treated films were evaluated.

Evaluation of the adhesiveness: Fluoropolymer film was fusion-pressure bonded to a substrate of PMMA (polymethyl methacrylate), nylon 12 or polyurethane rubber, or to a substrate of glass or SUS304 stainless steel through a silane coupling agent as applied thereto. In that state, the fusion-pressure bonded fluoropolymer films were cross-cut into 100 squares, 1 mm×1 mm, in a region of 10 mm×10 mm and their adhesiveness was evaluated by a cross-cut test and a cross-cut tape peeling test

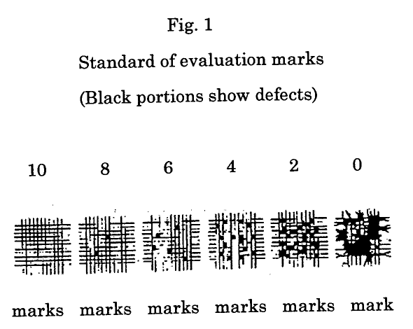

Evaluation was made by ranking of 0 mark, 2 marks, 4 marks, 6 marks, 8 marks and 10 marks in the order from heavy defects towards light defects, as given in the Standard for Evaluation Marks in FIG. 1 show defects as black portions. In the following Table, the ranking of 0 to 2 marks is shown as poor (X), that of 3 to 7 marks as fair (Δ), and that of 8 to 10 marks as good (ο).

Evaluation of chemical resistance: A 0.5 mm-thick substrate of PMMA, nylon 12 or polyurethane rubber was sandwiched between 2 fluoropolymer films, each surface-treated only on one side, so that the surface-treated sides of the films could be bonded to the substrate, followed by fusion-pressure bonding under the pressure bonding conditions in the following Table to make a laminate. The resulting laminates were dipped in 10 wt. % hydrochloric acid at 23° C. for 8 hours, and the laminates without any substantial weight change were evaluated as good (ο), those with some weight change as fair (Δ), and those suffered from film peeling as poor (X).

### Comparative Examples 2 to 4

In Examples 1 to 3, a CF₄ gas was used in the plasma treatment under the same conditions in place of the ammonia gas.

### Comparative Examples 5 to 7

In Examples 1 to 3, no plasma treatment by the ammonia gas was carried out.

Results of evaluation in the foregoing Examples and Comparative Examples are given in the following Table together with fluoropolymer film type, plasma treatment conditions and pressure bonding conditions.

TABLE

| | Example | | | Comparative Example | | | | | | |
|---|---|---|---|---|---|---|---|---|---|---|
| | 1 | 2 | 3 | 1 | 2 | 3 | 4 | 5 | 6 | 7 |
| [Polymer film] | A | B | C | D | A | B | C | A | B | C |

[Plasma treatment conditions]

| | | | | | | | | | | |
|---|---|---|---|---|---|---|---|---|---|---|
| Rf output (W) | 500 | 300 | 100 | 500 | 500 | 300 | 100 | — | — | — |
| Treating time (min.) | 20 | 10 | 15 | 20 | 20 | 10 | 15 | — | — | — |

[Pressure bonding conditions]

| | | | | | | | | | | |
|---|---|---|---|---|---|---|---|---|---|---|
| Temperature (° C.) | 260 | 230 | 220 | 350 | 260 | 230 | 220 | 260 | 230 | 220 |
| Pressure (MPa) | 5 | 3 | 1 | 5 | 5 | 3 | 1 | 5 | 3 | 1 |
| Time (Min.) | 10 | 5 | 7 | 10 | 10 | 5 | 7 | 10 | 5 | 7 |

[Adhesiveness evaluation]

| | | | | | | | | | | |
|---|---|---|---|---|---|---|---|---|---|---|
| PMMA | ◯ | ◯ | ◯ | — | X | X | X | X | X | X |
| Nylon 12 | ◯ | ◯ | ◯ | — | X | X | X | X | X | X |
| Polyurethane rubber | ◯ | ◯ | ◯ | — | X | Δ | Δ | X | X | Δ |
| Glass | ◯ | ◯ | ◯ | X | Δ | Δ | Δ | X | X | X |
| SUS304 | Δ | Δ | Δ | X | X | X | X | X | X | X |

[Chemical resistance evaluation]

| | | | | | | | | | | |
|---|---|---|---|---|---|---|---|---|---|---|
| PMMA | ◯ | ◯ | ◯ | X | X | X | X | X | X | X |
| Nylon 12 | ◯ | ◯ | ◯ | X | X | X | X | X | X | X |
| Polyurethane rubber | ◯ | ◯ | ◯ | X | X | X | X | X | X | X |

The present surface-treated perfluoropolymer moldings not only have a good chemical resistance and can undergo heat fusion bonding to other substrates, but also have anti-soil property, good water and oil repellancy, non-tackiness, low friction characteristics, etc. due to the nature of fluoropolymers, and thus can be used as laminates or integrated products such as films, sheets, tubes, pipes, hoses, belts, rods, blocks, bottles, tanks, etc. These laminates or integrated products are suitable for uses requiring chemical resistances, visibility, low fuel oil permeability, etc. such as chemical solution tubes, fuel hoses, etc.

What is claimed is:

1. A fluoropolymer molding, which comprises a molding of perfluoropolymer capable of undergoing low-temperature melt molding and having a calorimetric value of crystal fusion of not more than 10 J/g and a melt flow rate (MFR; 230° C.) of 0.1 to 100 g/min., the molding having a surface modified to have bonds of nitrogen atom origin.

2. A fluoropolymer molding according to claim 1, wherein the perfluoropolymer is a tetrafluoroethylene-perfluoro(alkyl vinyl ether) copolymer.

3. A fluoropolymer molding according to claim 1, wherein the perfluoropolymer has a high fluorine content polymer having a fluorine content of not less than 72 wt. %.

4. A fluoropolymer molding according to claim 2, wherein the perfluoropolymer has a high fluorine content polymer having a fluorine content of not less than 72 wt. %.

5. A fluoropolymer molding according to claim 1, wherein modification to the surface having bonds of nitrogen atom origin is carried out by electric discharge treatment in an ammonia gas atmosphere.

6. A fluoropolymer molding according to claim 1, wherein the molding is in the form of film, sheet, tube, pipe or hose.

7. A laminate, which comprises a surface-treated fluoropolymer molding according to claim 1, and a substrate.

8. A laminate according to claim 7, wherein the substrate is made of resin or rubber.

9. A laminate according to claim 8, wherein the substrate made of resin is a substrate of polyacrylate-based resin or polyamide-based resin.

10. A laminate according to claim 8, wherein the substrate made of rubber is a substrate of polyurethane rubber.

11. A laminate according to claim 7, wherein the lamination is carried out by heat fusion bonding.
